(19) United States
(12) Patent Application Publication
(10) Pub. No.: US 2009/0237306 A1
(43) Pub. Date: Sep. 24, 2009

(54) COMPACT INTEGRATED MONOPOLE ANTENNAS

(75) Inventors: Jau-Jr Lin, Gainesville, FL (US); Hsin-Ta Wu, Gainesville, FL (US); Kenneth K. O, Gainesville, FL (US)

Correspondence Address: SALIWANCHIK LLOYD & SALIWANCHIK;A PROFESSIONAL ASSOCIATION, PO Box 142950, GAINESVILLE, FL, 32614, US

(73) Assignee: UNIVERSITY OF FLORIDA RESEARCH FOUNDATION, INC, Gainesville, FL (US)

(21) Appl. No.: 12/095,853

(22) PCT Filed: Nov. 30, 2006
(86) PCT No.: PCT/US2006/061412

§ 371 Date: Sep. 2, 2008

Related U.S. Application Data
(60) Provisional application No. 60/741,926, filed on Dec. 2, 2005.

(51) Int. Cl. H01Q 1/38; H01Q 23/00

(52) U.S. Cl. 343/700 MS

(57) ABSTRACT

A compact integrated monopole antenna is provided, where the antenna can include a bulk semiconducting substrate, an electrically conductive antenna element disposed on said substrate, where the antenna element extending continuously along an antenna element path spanning an antenna length in a first direction. The antenna also can include a plurality of spaced apart electrically conductive grounding elements disposed on the substrate, where a first of the plurality of grounding elements is disposed on a first side of the antenna path along the antenna length and a second of the plurality of grounding elements is disposed on the other side of the antenna path along the antenna length, where the plurality of grounding elements is configured to effectively lengthen the antenna length as compared to a linear ground plane.

### CROSS-REFERENCE TO RELATED APPLICATION

This application is the national stage entry of International Application No. PCT/US2006/061412, filed XNov. 30, 2006, which claims priority to U.S. Provisional Patent Application No. 60/741,926, filed Dec. 2, 2005, both of which are incorporated in their entireties herein.

### STATEMENT REGARDING FEDERALLY SPONSORED RESEARCH OR DEVELOPMENT

The United States Government has certain rights to this invention pursuant to an agreement with DARPA.

### FIELD OF THE INVENTION

The invention relates to monopole antennas and more specifically to compact integrated monopole antennas.

### BACKGROUND

With the advent of ubiquitous wireless communications between and among people and other devices, inexpensive devices that support wireless communications are highly desirable. As a result, antennas on integrated circuits (IC's) have become irresistibly important for certain applications. In general, most integrated antennas have been targeted to operate at frequencies of 10 GHz and higher, much higher than the typical operating frequencies for consumer products. This limitation on frequency is primarily because of the increased physical antenna size required for lower frequency operation. For example, transistors having fₜ values of about 10 GHz will generally permit RF circuit operation up to about 2.4 GHz. However, at 2.4 GHz, the free space wavelength is 125 mm. Thus, on chip integration of a conventional resonant antenna, such as a half wave or quarter wave antenna, is clearly not practical for 2.4 GHz operation as the chip would require dimensions of about 62.5, or 31.25 mm, respectively, much larger than the available chip area in typical current consumer devices.

In general, attempts to reduce the size of integrated antennas have met with limited success. In some solutions, a spiral-type antenna has been used to obtain operation at a lower frequency. However, some antennas still require a considerable amount of area on the chip to be fully implemented, increasing the overall chip dimensions. In another solution, narrow dipole antennas have been used to increase antenna length. Such antennas are small in overall area due to their narrow width, however, one or more of the actual physical dimensions of the antenna must be increased to a large size in order to allow the antenna to operate at lower frequencies, again necessitating an often impermissible increase in overall chip area. Therefore, a need exists for compact integrated monopole antennas that provide operation in the frequency range of 1 GHz to several GHz.

### SUMMARY OF THE INVENTION

An integrated monopole antenna includes a bulk semiconducting substrate and an electrically conductive antenna element disposed on said substrate, where the antenna element extends continuously along an antenna element path spanning an antenna length in a first direction. The antenna can further include a plurality of spaced apart electrically conductive grounding elements disposed on the substrate, where a first of the plurality of grounding elements is disposed on a first side of the antenna path along the antenna length and a second of the plurality of grounding elements is disposed on the other side of said path along the antenna length, where the plurality of grounding elements is configured to effectively lengthen said antenna length as compared to a linear ground plane. The antenna provides operation in the frequency range of 1 GHz to several GHz.

The monopole antenna can be further configured such the first of the plurality of grounding elements and the second of the plurality of grounding elements are oriented symmetrically with respect to the antenna element.

The monopole antenna can also include the antenna element path is substantially linear or where it is defined by a periodic function.

The monopole antenna can also have a portion of the antenna path extend in a second direction, where the second direction is different from the first direction.

The monopole antenna can also be configured such that all of the plurality of grounding elements include at least one substantially linear grounding element segment. In some instances, the grounding element segments can extend substantially in the first direction. In other instances, the grounding element segments can extend substantially in a second direction, where the second direction is substantially perpendicular to the first direction.

The monopole antenna can include a substrate having a bulk resistivity at 25° C. is at least 20 ohm-cm or at least 100 ohm-cm, depending on the application. The substrate can also be a thinned substrate having a thickness of 5 to 50 μm.

The monopole antenna can further include at least one low-loss layer disposed beneath the substrate, wherein the low-loss layer provides a thermal conductivity of at least 35 W/m·K and electrical resistivity at 25° C. greater than 100 ohm-cm.

The monopole antenna can further include a passivation layer coating on at least a portion of the antenna element and the plurality of grounding elements. The passivation layer can have a dielectric constant of at least 20.

The monopole antenna can also be configured such that the antenna element and the plurality of grounding elements are placed within 2 mm of an edge of said substrate.

The monopole antenna can also have the antenna element coupled to an active portion of a circuitry element disposed on said substrate and the plurality of grounding elements are coupled to a grounding portion of a circuitry element, where the circuitry element can be a transceiver, a transmitter, or a receiver.

### BRIEF DESCRIPTION OF THE DRAWINGS

A fuller understanding of the present invention and the features and benefits thereof will be accomplished upon review of the following detailed description together with the accompanying drawings, in which:

FIG. 1 illustrates an exemplary embodiment of a compact integrated monopole antenna.

FIG. 2 illustrates exemplary antenna element designs for a compact integrated monopole antenna

FIGS. 3(a)-3(c) illustrate exemplary arrangements for the antenna element for a compact integrated monopole antenna.

FIG. 4 illustrates an exemplary schematic for a compact integrated monopole antenna coupled to a wireless communications device.

FIGS. 5(a)-5(b) illustrate exemplary arrangement for a compact integrated monopole antenna formed using multiple layer technique.

FIG. 6 shows measured input reflection loss (|S₁₁|) as a function of frequency for exemplary compact integrated monopole antenna structures with varying ground plane width (W).

FIG. 7 shows measured radiation patterns for exemplary compact integrated monopole antenna structures with varying grounding element width (W).

FIG. 8 shows measured |S₁₁| as a function of frequency for exemplary compact integrated monopole antenna structures with varying grounding element length (S) and varying antenna length (L).

FIG. 9 shows measured |S₁₁| as a function of frequency for exemplary compact integrated monopole antenna structures with varying grounding element width (W).

FIG. 10 shows measured radiation patterns for exemplary compact integrated monopole antenna structures with varying grounding element length (S).

FIG. 11 shows measured |S₁₁| as a function of frequency for exemplary compact integrated monopole antenna structures having a linear or zigzag antenna element.

FIG. 12 shows measured radiation patterns for exemplary compact integrated monopole antenna structures with varying grounding width (W) and grounding length (S).

FIG. 13 shows measured antenna pair gain (Gₐ) vs. separation (up to 4 m), for exemplary compact integrated monopole antenna structures with varying grounding width (W) and grounding length (S), at 52 cm from the ground.

FIG. 14 shows measured Gₐ, at 5.8 GHz, vs. separation (up to 4 m) for exemplary compact integrated monopole antenna structures with varying grounding length (S) at 52 cm from the ground.

FIG. 15 shows normalized measured radiation patterns of various compact integrated monopole antenna structures.

FIG. 16 shows measured Gₐ vs. separation for exemplary integrated compact monopole antenna having antenna length of 6 mm at 5.8 GHz, at 52 cm and 5 mm from the ground, and a 3 mm dipole pair at 52 cm and 5 mm from the ground at 24 GHz.

### DETAILED DESCRIPTION OF THE INVENTION

Embodiments in accordance with the present disclosure provide for compact integrated monopole antennas. The embodiments described herein provide for monopole antennas unexpectedly operating at frequencies which normally require dipole antennas being double in length, as shown in the exemplary devices discussed herein.

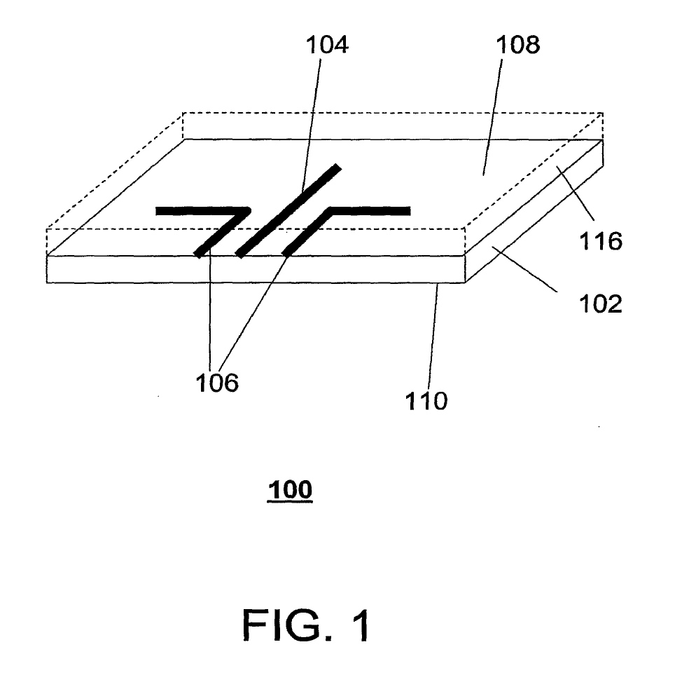

FIG. 1 shows an exemplary embodiment of an integrated compact monopole antenna structure 100 mainly comprising a bulk semiconducting substrate 102, an antenna element 104, and a plurality of grounding elements 106 located towards one end of the antenna element 104. In the various embodiments, the grounding elements 106 are disposed on both sides of the antenna element 104, operating to provide the reflection of the antenna element 104, effectively increasing the antenna length and allowing for resonance at a lower frequency.

The substrate 102 has a first surface 108 (top surface) and a second surface 110 (bottom surface), wherein the antenna element 104 and the grounding elements 106 are disposed on the first surface of the substrate 108. Although the bulk semiconducting substrate 102 is generally a silicon substrate, the substrate 102 can be a variety of others including silicon on insulator (SOI), SiGe, or Silicon on Anything (SOA). SOA is a technique to transfer silicon wafer to a dielectric substrate, after the processing is completed. However, when Si substrates with a resistivity less than about 20 Ω-cm are used, the power transmission gain (Gₐ) of integrated antennas can significantly degrade due to conduction loss. Although, systems according to the invention can be made to work with low substrate resistivity, antenna structures on such substrates will generally require a larger transmitted power and dc power consumption. To address this issue, the invention can use substrates with bulk resistivity ranging from 50 to 100 Ω-cm or higher, or use of alternate substrates, such as SOI which dispose a thin layer of semiconductor over a dielectric such as silicon dioxide or sapphire. Alternatively, conventional substrates can be thinned to a thickness on the order of 5 to 250 μm to reduce the volume associated with lossy substrate in order to improve the power transmission gain (Gₐ). Following thinning the wafer to the desired thickness, the wafer can be transfer to another support, including a package (e.g. plastic). The support can be a thin high permittivity dielectric material selected to provide low loss and isolation from the earth ground plane.

Also because low resistivity substrates (e.g. <1 Ω-cm) can significantly degrade the performance of an integrated antenna, a separate low loss insert layer can be disposed between a thinned substrate (e.g. silicon) and other components. Additionally, a low loss passivating layer 116 can encapsulate at least a portion of the antenna or other radio components. The low loss dielectric thickness can be selected to match the environment (e.g. air). Exemplary layers which can satisfy the above parameters include sapphire (Al₂O₃), diamond, AlN, and high resistivity silicon. For high resistivity silicon, the silicon can have a resistivity of at least 20 Ω-cm, preferably at least 100 Ω-cm, and more preferably at least 1000 Ω-cm.

A low loss dielectric propagating layer can also be integrated between any other conductive materials and the antenna element 104 and grounding elements 106 to provide better isolation. In at least one embodiment of the invention, the substrate can include a silicon dioxide layer disposed on the first surface 108 of the substrate 102, but other dielectric materials can be used.

In the various embodiments, the antenna element 104 and the grounding elements 106 can be electrically conductive materials disposed on the substrate 102. The selection of electrically conductive materials can be based upon the processing technology used for circuitry being disposed on the same chip. Although CMOS technology is generally preferred for forming the circuitry because of cost and since the most advanced digital technologies are available first as CMOS technology, the invention, when accompanied by circuitry, is in no way limited to CMOS, as it can be practiced, for example, using bipolar or BIMOS technology as well.

In at least one embodiment, the antenna element 104 and the grounding elements 106 can be formed from a patterned Al—Cu alloy disposed on the first surface 108 of the substrate 102. However, the invention is not limited in this regard and other electrically conductive materials, including highly doped semiconductor materials or metals, including Al, Cu, Ti, W, or any other conductive materials compatible with the fabrication method being used, can be used to form the antenna element 104 and the grounding elements 106.

In general, the minimum distance required between the antenna element 104 and the grounding elements 106 is dictated by the processing limits of the fabrication method being used, such that the antenna element 104 and the grounding elements 106 are kept electrically isolated. It can be appreciated that the line widths and layer thicknesses can vary according to the fabrication technology used, the patterning methods employed, and the design rule set. Although increased line width can improve antenna performance, it can be appreciated that increasing line width also increases the area required by the antenna structure 100.

In the various embodiments, the thickness and permittivity of the coating layer (passivation) 116 that is currently used for protecting the IC from the environment is selected to also improve the performance of the antenna structure 100. The passivation layer 116 can coat the entire antenna structure 100 or only a portion thereof, such as the second surface 110 of the substrate 102. In such embodiments, the coating layer parameters can depend on the frequency range of operation for the antenna structure 100. For example, for 5.8 GHz operation, a passivation coating thickness of about a few mm's with a low loss material having a dielectric constant of at least 20, such as 100 can improve the impedance match of the antenna to free space. The matching works analogous to that of an anti-reflection coating. The antenna can see high dielectric constant coating, which would shorten the wavelength of the waves propagating therethrough. Shorter wavelength waves can mean a higher efficiency antenna or the ability to reduce the length of the antenna element 104.

Grounding elements 106 provided be disposed adjacent to one end of the antenna element 104 to provide reflection of as much of the antenna length as possible, thus increasing the effective length of the antenna element 104. Therefore, the distance between the antenna element 104 and the grounding elements 106 should remain below 2.5 mm, as the grounding elements 106 would no longer provide a effective reflection of the antenna element 104.

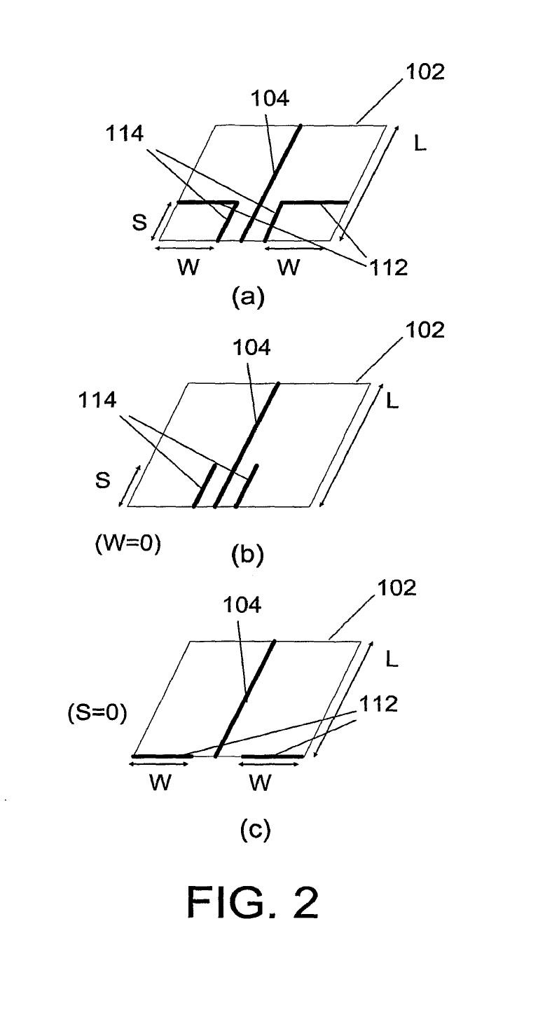

In the illustrated embodiment, as shown in FIGS. 2(a)-2(c), a linear antenna element 104 is provided, extending in a first direction an antenna length (L). As is well-known in art, increasing the length of the antenna element 104 allows the antenna structure 100 to operate to lower frequencies. In general, when the antenna structure 100 operates at a specific frequency, it is effective for a range of frequencies usually centered on that resonant frequency. However, the other properties of the antenna structure 100 (especially radiation pattern and impedance) change with frequency, so the resonant frequency of the antenna structure 100 can merely be close to the target frequency of these other more important properties. Therefore, an antenna structure 100 can be made resonant on harmonic frequencies with lengths that are fractions of the target wavelength instead. In some embodiments, ½ or ¼ wavelength can be used in order to determine the proper length of the antenna element 104 to provide an appropriate resonant frequency for the antenna structure 100.

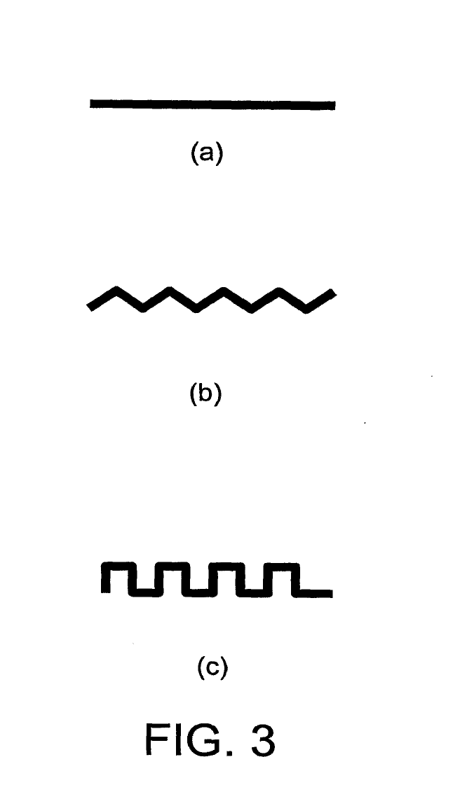

However, the antenna element 104 need not be a linear structure and can have one or more portions of the antenna element 104 extending in disparate directions and having disparate lengths. As illustrated in FIG. 3, alternative antenna element structures can be provided to allow the overall length of the antenna element 104 to be reduced without affecting resonant frequency. For example, the antenna element 104 can also comprise a zigzag or meandering patterned antenna element 104, as shown in FIGS. 3(b) and 3(c), respectively. Such designs are provided by way of example, not limitation. Additionally, the antenna element 104 can be modified or customized for the specific application. In some embodiments, the antenna pattern can also be defined by a complex mathematical function or a combination of periodic and non-periodic functions, depending on the application for the antenna structure 100. For example, at least a portion of the antenna element 104 can be defined by a log periodic zigzag pattern rather than a regular zigzag pattern. Similarly, a meandering structure, as shown in FIG. 3(c), can also be modified or customized as needed, or defined by a more complex mathematical function.

The design of grounding elements 106 can also be varied as needed to reduce area of the antenna structure 100. In general, a monopole antenna comprises an antenna element 104 extending perpendicularly from a midpoint of a substantially linear ground plane having a total width equal to at least ¼ of the wavelength being used in order to provide good antenna performance. However, the larger the grounding plane is, the more ideally the antenna structure 100 will perform and the less susceptible to interference the antenna structure 100 will be.

The illustrated examples in FIGS. 2(a)-2(c) show some ways in which the geometry of the grounding elements 106 can be varied. In FIGS. 2(a)-2(c), the antenna length (L) of a linear antenna element 104 defines the overall resonant frequency of the antenna structure 100. The design of the grounding elements 106 can provide a width (W) and length (S), to allow for overall reduction of chip area being used by the antenna structure, but still providing a relatively large grounding plane.

In the illustrated example in FIG. 2(a), each of the grounding elements 106 includes a segment 114, parallel to the antenna element 104, defining the grounding length (S) of the grounding element 104 and a segment 112, perpendicular to the antenna element 104, defining the width (W) of the grounding element 104. In such embodiments, the grounding plane can be formed from the net effect of the grounding segments 112 and 114, providing an effectively longer grounding plane, thus improving the monopole characteristics of the antenna structure 100.

As shown in the illustrated example in FIG. 2(b), the grounding width (W) can be adjusted to equal or approach 0, forming a grounding sleeve. Despite the lack of a perpendicular grounding element segment, the grounding sleeve still functions as a grounding plane for the antenna element 104. However, the lack of a perpendicular component minimizes the size of the antenna structure 100, thus reducing the area needed. Alternatively, as shown in the illustrated example in FIG. 2(c), the grounding length (S) can also be adjusted to equal or approach 0, approximating the ideal monopole grounding plane and performance, but still resulting in a smaller the antenna structure 100 compared to a dipole antenna structure operating at the same frequency.

Therefore, by varying the overall dimensions of the antenna element 104 and the dimensions and design of the grounding elements 106, the overall dimensions of the antenna structure 100 can be adjusted to provide monopole antenna performance within a compact area on a substrate 102. Additionally, by varying the design of the antenna element 104, the resonant frequency of the antenna structure 100 can be configured to operate at a desired frequency without having to increase the area of the antenna structure 100 and without significant degradation in antenna performance.

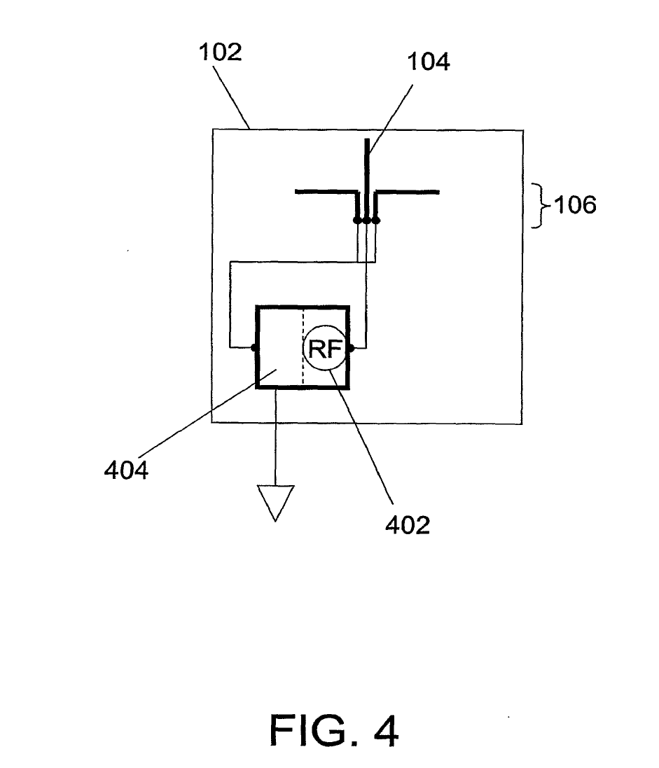

The antenna element 104 and the grounding elements 106 can also be coupled to circuitry elements disposed on the substrate 102. In at least one embodiment, the circuitry elements can comprise a wireless communications device, such as a transceiver, a receiver, or a transmitter, where the antenna element can be coupled to the active portion 402 of the wireless communications device and the grounding elements can be coupled to the grounding portion 404 of the wireless communications device, as shown in FIG. 4. In some embodiments, each of the pair of grounding elements can be coupled separately to the grounding portion of the radio device. However, in other embodiments, an additional grounding element can be provided to couple the grounding elements together, in order to provide a single continuous grounding plane. Such embodiments reduce the number of connections to the grounding plane, as well as provide an increased ground plane length, improving the monopole antenna characteristics.

Additionally, by reducing or increasing the dimensions of grounding elements 106, including reducing or increasing the metal line dimensions, the input impedance of the antenna structure can also be adjusted to match an output impedance of a radio device. For example, as grounding length (S) and/or grounding width (W) are reduced or increased, the total resistance of the grounding elements 106 is increased or reduced, respectively, allowing for better matching.

In some embodiments, the antenna can be included in an existing layer of the transceiver fabrication process, wherein a reduced area for the antenna is desired. In other embodiments, the antenna formation comprises processing at a different level, allowing for use of a larger area antenna. In the various embodiments, the placement of the antenna can be configured such that any interference between the components of the radio device and the integrated antenna is minimized. For example, placing the antenna structure 100 along the edge of a chip reduces losses associated with wave attenuation due to the substrate (e.g., silicon) and reduces the impact of integrated antennas on area available on a chip. Generally, antennas can be placed within 6 mm of an edge of the chip. However, the maximum preferred distance from the edge of a chip will vary based on frequency and substrate resistivity.

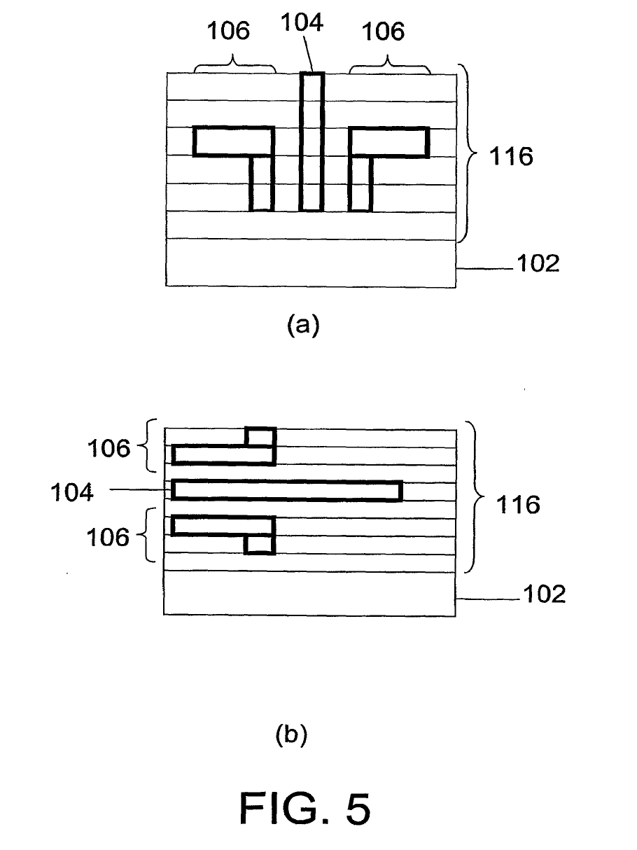

Additionally, in some embodiments, the antenna structure 100 need not be a planar structure as shown in FIG. 1, rather the antenna element 104 and the grounding elements 106 can be oriented perpendicularly with respect to the substrate. For example, using CMOS fabrication techniques, the antenna element 104 and the grounding elements 106 can be formed between several passivation layers 116 disposed on the substrate 102, to allow the antenna to extend vertically from the substrate, as shown in FIG. 5(a) or be oriented perpendicularly to the substrate, as shown in FIG. 5(b).

### EXAMPLES

It should be understood that the exemplary compact integrated monopole structures described herein are for illustrative purposes only and that various modifications or changes in light thereof will be suggested to persons skilled in the art and are to be included within the spirit and purview of this application. The invention can take other specific forms without departing from the spirit or essential attributes thereof.

Table 1 below lists the various antenna structures used for the various measurements discussed herein. The antenna structures tested were formed using a 2 μm thick Al—Cu alloy layer and were fabricated on a 20 Ω-cm silicon substrate with 3 μm silicon oxide thickness thereon, the substrate having a 750 μm thickness. Each metal line width was 30 μm. The minimum distance between metal lines was ˜15 μm.

| | Antenna | Ground | Ground | |
|---|---|---|---|---|
| Structure | length (L) | width (W) | length (S) | |
| a-1 | 6 mm | 6 mm | 0 | mm |
| a-2 | 6 mm | 4.5 mm | 0 | mm |
| a-3 | 6 mm | 3 mm | 0 | mm |
| b-1 | 6 mm | 6 mm | 0.4 | mm |
| b-2 | 6 mm | 6 mm | 0.6 | mm |
| b-3 | 3 mm | 3 mm | 0.4 | mm |
| b-4 | 3 mm | 3 mm | 0.6 | mm |
| b-5 (zigzag) | 6 mm | 6 mm | 0.3 | mm |
| b-6 (zigzag) | 6 mm | 6 mm | 0.5 | mm |
| c-1 | 6 mm | 0 mm | 1.2 | mm |
| c-2 | 6 mm | 0 mm | 0.9 | mm |
| c-3 | 6 mm | 0 mm | 0.6 | mm |

As discussed herein, the structures a-1, a-2, and a-3 most closely resembled the illustrated embodiment shown in FIG. 2(c), whereby the antenna structure approximates the ideal monopole structure. Structures b-1, b-2, b-3, b-4, b-5, and b-6 most closely resemble the illustrate embodiment in FIG. 2(a), whereby the antenna structure maximizes the ground plane length/size. Additionally, structures b-5 and b-6 incorporate an antenna element 104 utilizing a zigzag pattern similar to the one shown in FIG. 3(b), whereby the antenna length is lengthened. Finally, structures c-1, c-2, and c-3 most closely resemble the illustrated embodiment in FIG. 2(b), whereby the area of the antenna structure is minimized. All measurements were performed at 25° C.

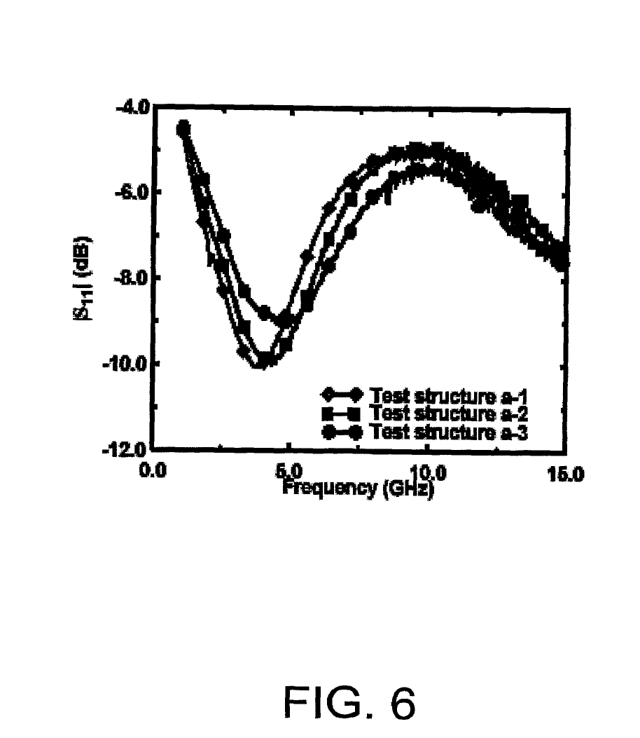

FIG. 6 shows the measured input reflection loss (|S₁₁|), as a function of frequency, for antenna structures having a grounding length (S) of 0 mm (S) and an antenna length (L) of 6 mm (structures a-1, a-2, and a-3), similar to the structure illustrated in FIG. 2(c), which most closely approximates the ideal monopole antenna. As shown by the measurements, an antenna length (L) of 6 mm sets the resonance frequency to just below 5 GHz. However, by decreasing the grounding width (W), the structure can move father away from the ideal monopole structure, resulting in decreased gain and a shift in resonance frequency, as shown by the difference between the curves in FIG. 6. However, only a slight decrease in the grounding width (W), as shown in the curve for a-2, results in only a slight frequency shift with little or no loss in gain. In general, when the antenna structure 100 operates at a specific frequency, it is effective for a range of frequencies usually centered on that resonant frequency. Therefore in the various embodiments, small shifts in the grounding width (W) can be used to reduce antenna size without any significant change in performance. For example, as shown in FIG. 6, the 1.5 mm shift in grounding width (W) between structures a-1 and a-2 provides comparable antenna performance, but a 25% reduction in area needed by the antenna structure 100.

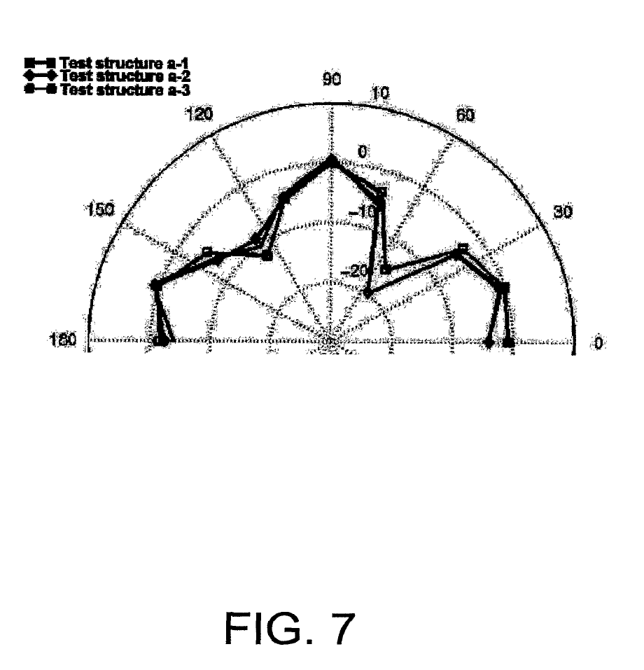

FIG. 7 shows the measured radiation patterns for antenna structures having a grounding length (S) of 0 mm and an antenna length (L) of 6 mm (structures a-1, a-2, and a-3), similar to the structure illustrated in FIG. 2(c). The radiation pattern plots the antenna pair gain of two identical antennas, normalized to that for structure a-1, where the antenna pair gain, Gₐ, is as defined by:

$$\begin{matrix}{G}_{a} = \frac{{\vert {S}_{21} \vert}^{2}}{( 1 - {\vert {S}_{11} \vert}^{2} ) ( 1 - {\vert {S}_{22} \vert}^{2} )} \\ = {G}_{t} {{G}_{r} ( \frac{λ}{4 π R} )}^{2}\end{matrix}$$

As shown in FIG. 7, the radiation patterns for the structures with a 0 mm grounding length (S) showed that variations in the grounding width (W) only have a minor effect on the measured radiation pattern of the antenna structure. As a result, the grounding width (W) can be reduced, for example, from 6 mm to 4.5 mm, which corresponds to a 25% reduction antenna area, without any significant impact on radiation patterns and or antenna performance, as previously discussed. In the various embodiments, this can allow the grounding width (W) to be reduced, reducing overall antenna size, allowing for a smaller antenna structure, without significant impact on antenna performance.

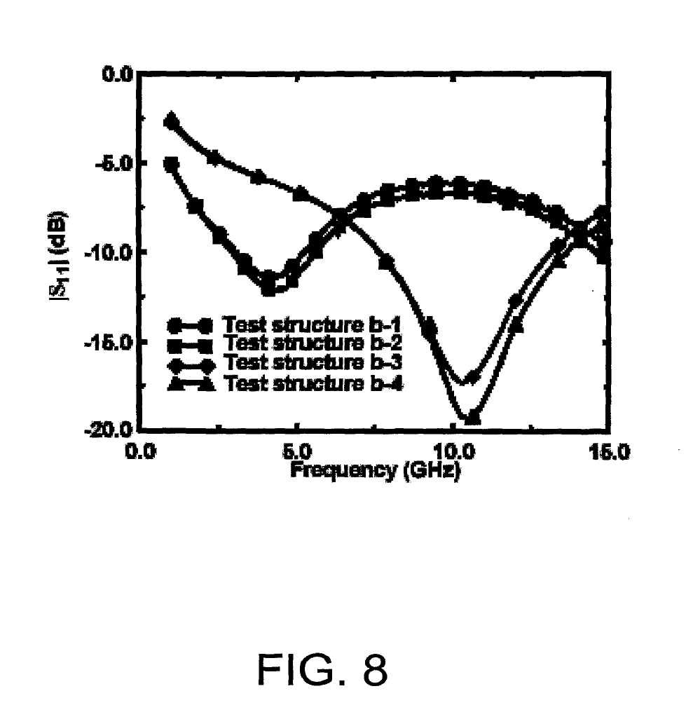

FIG. 8 shows |S₁₁| as a function of frequency for four different test structures (b-1, b-2, b-3, and b-4) with varying grounding length (S), similar to the structure illustrated in FIG. 2(a). Structures b-1 and b-2 utilize a 6 mm antenna length (L) and a 6 mm grounding width (W). Structures b-3 and b-4 utilize a 3 mm antenna length (L) and a 3 mm grounding width (W). Because of the difference in antenna length, b-1 and b-2, with the longer antenna length (L), have a lower resonance frequency than b-3 and b-4, with a shorter antenna length (L). However, the change in grounding length (S) from 0.4 mm to 0.6 mm has no significant impact on the resonance frequency itself. As shown in FIG. 8, the grounding length (S) can impact the gain at the resonance frequency, as shown by the higher relative gains of structures b-2 and b-4, which have the longer grounding length (S) of 0.6 mm. In the various embodiments, gain can be improved by having a longer grounding length (S), as this increases the size of the ground plane providing reflection for the antenna element 104. In other words, by reducing the input reflection losses (|S₁₁|), the gain is increased, as shown in the equation for Gₐ. Therefore, the ground plane size can be increased without necessarily increasing the grounding width (W), allowing a higher gain antenna to be fabricated on a substrate without the need for a larger area. An additional advantage of grounding length (S) is that the input impedance for the antenna structure 100 can also be increased or decreased without requiring adjustment of the grounding width (W) of the antenna structure 100.

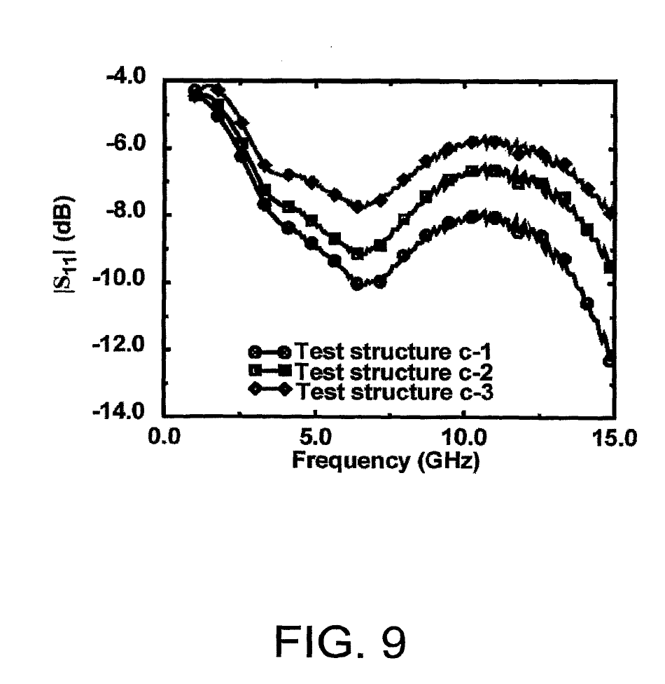

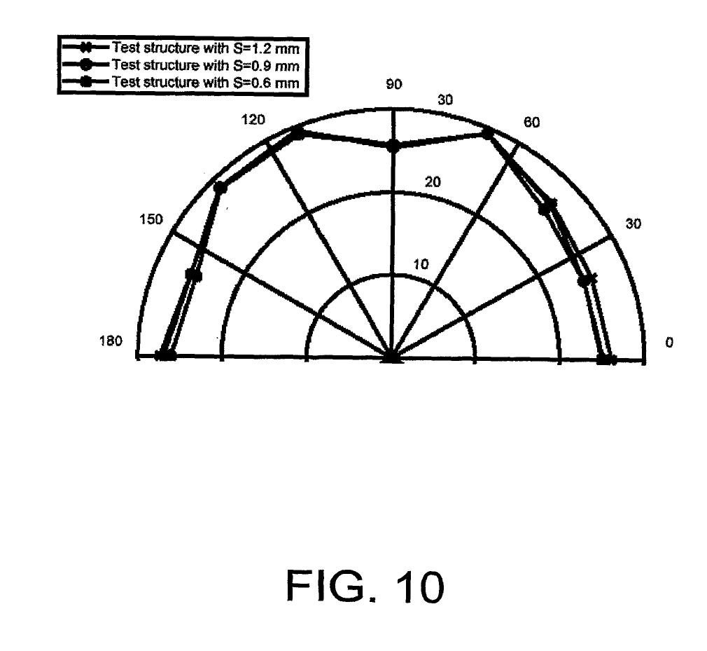

FIG. 9 shows |S₁₁| as a function of frequency for antenna structures c-1, c-2, and c-3 with varying ground lengths (S), 0.6 mm to 1.2 mm, with antenna lengths (L) of 6 mm and grounding widths (W) of 0 mm, similar to the illustrated antenna structure depicted in FIG. 2(b). In such structures, the ground element 106 has no perpendicular component; rather the ground element 106 is a “sleeve” that overlaps a portion of the antenna element 104. As shown by the measurements, the resonance frequency is unaffected by the changes in the grounding length (S). Furthermore, as shown in FIG. 10, the radiation pattern is generally unaffected by changes in the grounding length (S). In such embodiments, by reducing the grounding width (W) to zero any reduced gain can be recovered by increasing the grounding length (S), which results in an effective increase in the size of the ground plane and pushing the antenna performance of the antenna structure 100 back towards the ideal monopole case. Therefore, in the various embodiments, the grounding length (S) can be increased to improve gain when it is necessary to further reduce grounding width (W) because of chip area considerations and to provide a larger ground plane for the antenna structure 100 to behave more ideally.

Other methods are also contemplated for increasing effective antenna length without increasing area of the antenna structure 100. As previously discussed and illustrated in FIGS. 3(b) and 3(c), a zigzag or meandering antenna element 104 can be used in place of a linear antenna element 104 in any of the arrangements shown in FIGS. 2(a)-2(c), to increase effective antenna length (L) and seek a lower resonance frequency of operation.

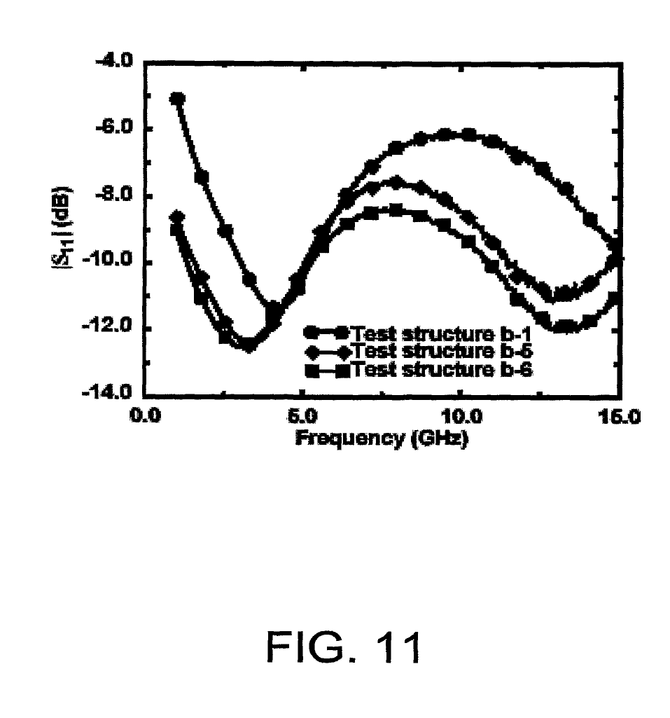

FIG. 11 shows |S₁₁| as a function of frequency for antenna structures utilizing of linear and zigzag antenna elements (b-1 (linear structure); b-5 and b-6 (zigzag structures)), where the antenna length (L) and the grounding width (W) are both 6 mm. In the linear structure, b-1, a 0.4 mm grounding length (S) is used, while in zigzag structures b-3 and b-5, 0.3 mm and a 0.5 mm grounding width (W), respectively, are used for the structures. The net effect of incorporating a zigzag structure is an overall increase in the antenna length (L), allowing a zigzag structure to be resonate at a lower frequency that a linear antenna with a similar physical length, as shown by the measured |S₁₁| for structures b-5 and b-6 in FIG. 11. Therefore, in the various embodiments, incorporating a zigzag or other type of antenna structure allows an additional degree of freedom in adjusting the antenna structure 100 to provide a lower resonance frequency for an existing design or to further reduce the needed antenna length (L) to configure an antenna structure 100 to operate at a lower frequency, allowing a more compact design.

In the illustrated embodiments, the combination of antenna length (L), grounding width (W), grounding length (S), and antenna element design pattern can be used to provide an antenna structure having an area small enough to be accommodated on a typical consumer chip, but capable of operating at frequencies substantially below 10 GHz. These variables can be used to design antennas having different areas and different input impedances, yet providing similar antenna gains and resonating frequencies. Such embodiments are advantageous in that they provide the chip designer several degrees of freedom in designing and placing an compact monopole antenna structure on a substrate 102.

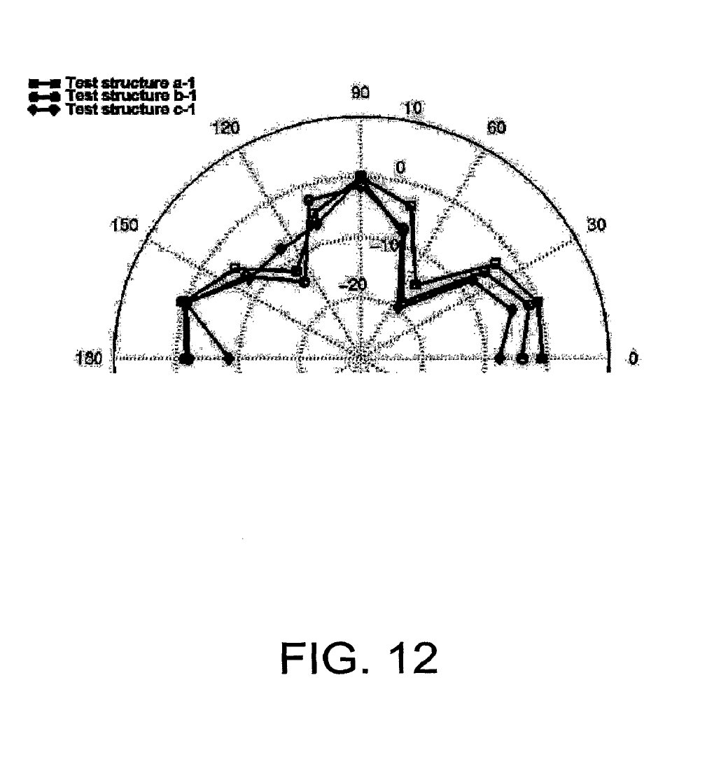

For example, FIGS. 12, 13, 14, and 15 show the Gₐ performance and radiation patterns comparisons of typical structures in accordance with embodiments of the present invention, where each of the structures corresponds to one of the structures illustrated in FIGS. 2(a)-2(c), but all operating approximately the same resonant frequency. The substrates containing the antennas were facing each other and the waves were propagated through the silicon substrate (90° point in FIG. 12).

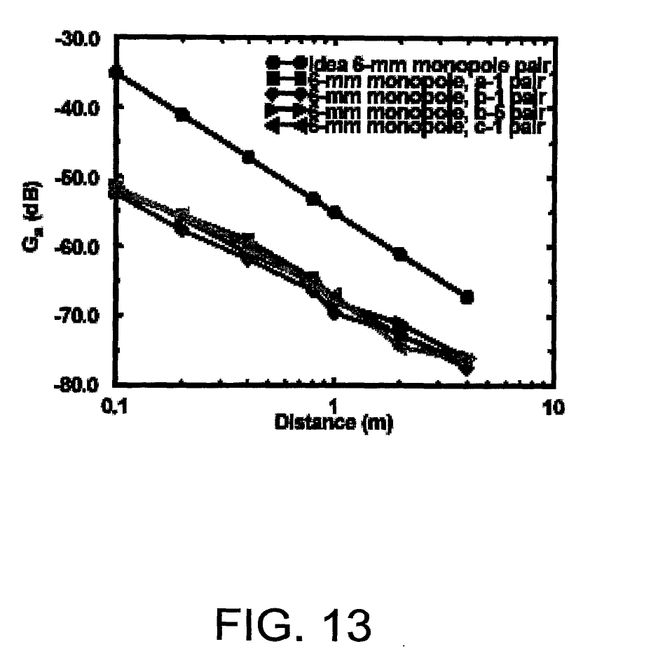

FIG. 12 shows radiation pattern measurements of structures b-1, a-1, and c-1, similar to the structures in FIGS. 2(a), 2(b), and 2(c), respectively, and each operating near 5 GHz. The radiation patterns are also normalized to that of a-1 structure. As shown in the measurements, Gₐ and radiation patterns are weakly dependent on the grounding width (W) and the grounding length (S), allowing the each of the antenna designs to be configured to operate at the same frequency without affecting the overall radiation pattern for the antenna. Although the pattern for the structure without a perpendicular grounding segment (c-1) is slightly more anisotropic, Gₐ's over distance are similar for all the structures, as shown in FIG. 13.

FIG. 13 shows Gₐ at 5.8 GHz versus separation for structures a-1, b-1, c-1 and b-5 (zigzag) at 52 cm from the ground. As shown in the measurements, although the dimensions of the antenna structures are different, each of the antenna structures has similar antenna pair gain at 5.8 GHz with over separation lengths of at least 4 m, with no significant loss. Therefore, in the various embodiments, as long as some form of ground plane is provided, even if just the sleeve structure in c-1, comparable antenna gains can be provided, allowing the designer to choose appropriate grounding element 106 designs based on impedance, available chip area, or allowable interference.

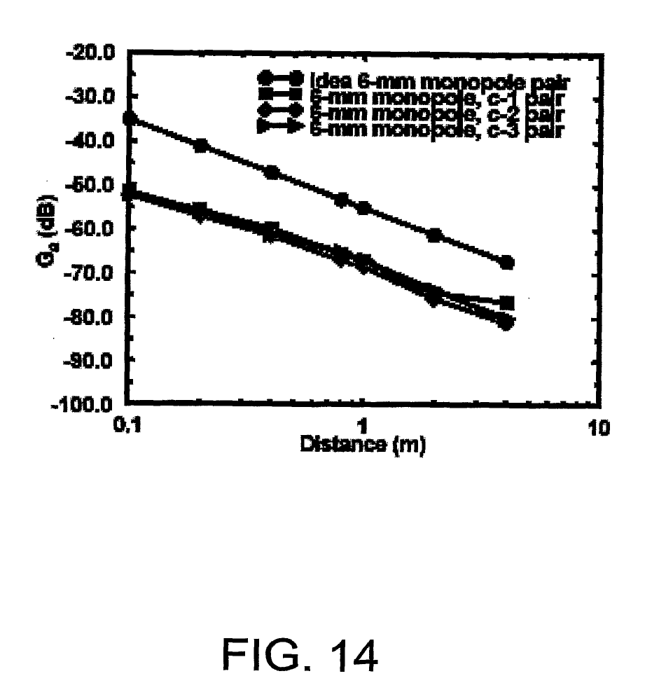

In FIG. 14, which shows antenna pair gains at 5.8 GHz, Gₐ, versus separation (up to 4 m) of c-1, c-2 and c-3 structures at 52 cm from the ground, it is also shown that further reduction in the grounding length (S) also appears to have no impact of the antenna pair gain as a function of separation. Therefore, in some embodiments, a single-chip radio can be configured with an antenna with the grounding width (W) altogether eliminated, reducing antenna structure area to as low as 0.73 mm² using the current fabrication methods of the exemplary devices. However, lower areas are contemplated as advancing design rules and fabrication methods allow for smaller line spacing and line widths in embodiments with grounding widths (W) equal to 0 mm, as shown in FIG. 2(b). Furthermore, adjustment of the grounding length (S) allows a design to adjust input impedance as needed.

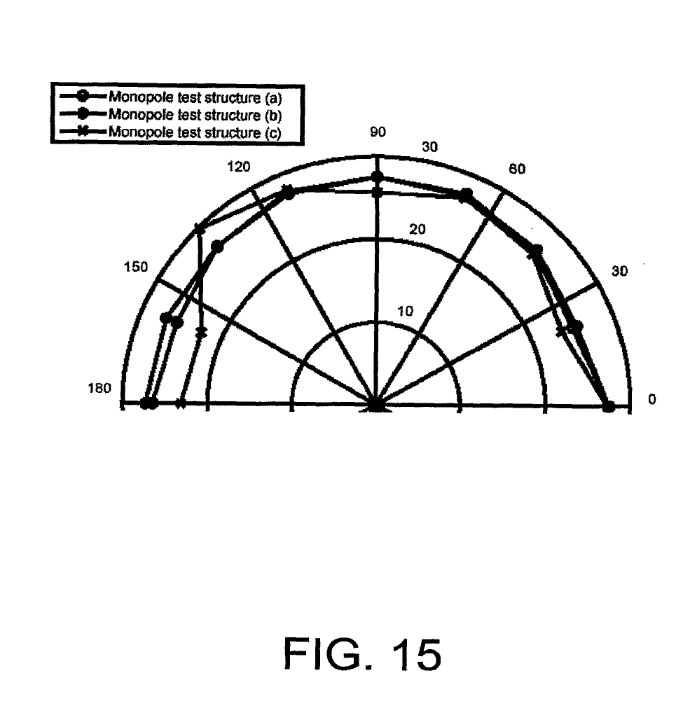

The flexibility of the design parameters is further illustrated in FIG. 15, which compares radiation patterns for antenna structures having equal antenna lengths, but other varying components. Test structure (a) in FIG. 15 is a structure similar to that in FIG. 2(c), in which the grounding length (S) is set to 0. Test structure (b) in FIG. 15 is a structure similar to FIG. 2(a), having a finite grounding length (S) and grounding width (W). Test structure (c) in FIG. 15 is a structure similar to FIG. 2(b), in which the grounding width (W) is 0 and having a finite grounding length (S). As shown in the measured radiation pattern in FIG. 15, the variation of design parameters shows no significant impact on the radiation pattern. Although the radiation pattern for test structure (c) is asymmetric, since this structure is the farthest from the ideal monopole, all radiation patterns are essentially similar, indicating that no impact on gain over distance should be perceived based on the design being used.

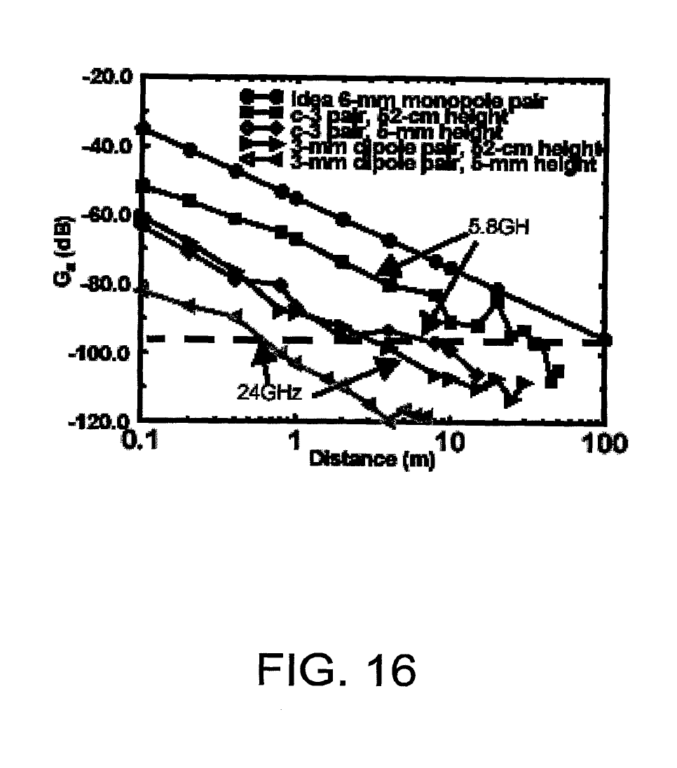

Such flexibility is advantageous because by extrapolating the results if the illustrated devices discussed about, it is possible to have acceptable gains for separation lengths of up to 30 m, necessary for consumer product applications, such as wireless phones, Bluetooth, 802.11x technologies, and other consumer oriented wireless technologies. Therefore, using the design variables disclosed herein, it is possible to provide compact integrated monopole antennas that provide substantial gain over previous designs in the art, even over distance. For example, FIG. 16 shows antenna pair gains, Gₐ, versus separation at 5.8 GHz for pair of antennas using the structure of c-3, similar to that illustrated in FIG. 2(c), at 52 cm and 5 mm from the ground and antenna pair gains, Gₐ, versus separation at 5.8 GHz for 3 mm dipole pairs, as known in the art, at 52 cm and 5 mm from the ground in the lobby. As shown by the measurements, when the antennas are located 52 cm from the ground, Gₐ of 6 mm monopole (c-3) pair at 5.8 GHz is more than 10 dB higher than that of the 3 mm dipole pair at 24 GHz. When the separation to the ground is reduced to ˜5 mm, the Gₐ plots are shifted down by ˜10 dB due to the ground reflection. Therefore it is possible to use structure c-3 to communicate over 30 to 40 meters. This is more than six times larger than that for the range for a pair of 3 mm dipole antennas at 24 GHz. When a pair of structure c-3 is located ˜5 mm from the ground, the range is ˜5 m, which is sufficiently large to be useful. This is once again more than six times larger than the range for a pair of 3 mm zigzag dipoles. Therefore, the exemplary devices demonstrate the unexpected result that a 6 mm monopole antenna can provide performance superior to a 3 mm dipole pair utilizing the same area on the chip.

It is to be understood that while the invention has been described in conjunction with the illustrated embodiments previously discussed, the foregoing description as well as the examples which follow are intended to illustrate and limit the scope of the invention. Other aspects, advantages, and modifications within the scope of the invention will be apparent to those skilled in the art to which the invention pertains.

We claim:

1. An integrated monopole antenna, comprising:
a bulk semiconducting substrate;
an electrically conductive antenna element disposed on said substrate, said antenna element extending continuously along an antenna element path, said path spanning an antenna length in a first direction;
a plurality of spaced apart electrically conductive grounding elements disposed on said substrate, wherein a first of the plurality of grounding elements is disposed on a first side of said antenna path along said antenna length and a second of the plurality of grounding elements is disposed on the other side of said path along said antenna length, said plurality of grounding elements configured to effectively lengthen said antenna length as compared to a linear ground plane.

2. The monopole antenna of claim 1, wherein the first of the plurality of grounding elements and the second of the plurality of grounding elements are oriented symmetrically with respect to the antenna element.

3. The monopole antenna of claim 1, wherein the antenna element path is substantially linear.

4. The monopole antenna of claim 1, wherein the antenna path is defined by a periodic function.

5. The monopole antenna of claim 1, wherein a portion of the antenna path extends in a second direction, said second direction being different from said first direction.

6. The monopole antenna of claim 1, wherein all of the plurality of grounding elements comprise at least one substantially linear grounding element segment.

7. The monopole antenna of claim 6, wherein the grounding element segments extend substantially in the first direction.

8. The monopole antenna of claim 6, wherein the grounding element segments extend substantially in a second direction, wherein the second direction is substantially perpendicular to the first direction.

9. The monopole antenna of claim 1, wherein a bulk resistivity of said substrate at 25° C. is at least 20 ohm-cm.

10. The monopole antenna of claim 1, wherein the substrate is a thinned substrate having a thickness of 5 to 50 μm.

11. The monopole antenna of claim 1, wherein a bulk resistivity of the substrate at 25° C. is at least 100 ohm-cm.

12. The monopole antenna of claim 1, further comprising at least one low-loss layer disposed beneath said substrate, wherein the low-loss layer provides a thermal conductivity of at least 35 W/m·K and electrical resistivity at 25° C. greater than 100 ohm-cm.

13. The monopole antenna of claim 1, further comprising a passivation layer coating on at least a portion of said antenna element and said plurality of grounding elements.

14. The monopole antenna of claim 13, the passivation layer having a dielectric constant of at least 20.

15. The monopole antenna of claim 1, wherein said antenna element and said plurality of grounding elements are placed within 6 mm of an edge of said substrate.

16. The monopole antenna of claim 1, wherein said antenna element is coupled to an active portion of a circuitry element disposed on said substrate and said plurality of grounding elements are coupled to a grounding portion of said circuitry element.

17. The monopole antenna of claim 16, wherein said circuitry element is at least one among a transceiver, a transmitter, and a receiver.
